(19) United States
(12) Patent Application Publication
(10) Pub. No.: US 2025/0189985 A1
(43) Pub. Date: Jun. 12, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TAICHI YUKI, TOKYO (JP)

(21) Appl. No.: 18/844,603

(22) PCT Filed: Feb. 16, 2023
(86) PCT No.: PCT/JP2023/005420

§ 371 Date: Sep. 6, 2024

(30) Foreign Application Priority Data
Mar. 16, 2022 (JP) 2022-040918

(51) Int. Cl. G05D 1/646; G05D 1/246; G05D 1/644; G05D 1/69; G05D 105/30; G05D 107/60; G05D 109/10

(52) U.S. Cl. CPC G05D 1/646; G05D 1/246; G05D 1/644; G05D 1/69; G05D 2105/315; G05D 2107/60; G05D 2109/10

(57) ABSTRACT

A mobile device is allowed to efficiently guide a guide target. A generation unit generates a travel instruction plan for a mobile device configured to guide a guide target, on the basis of environment map information on a facility in which the mobile device guides the guide target, mobility performance information on the mobile device, and current information and guide task information on the mobile device. For example, the generation unit decides on an area where the mobile device needs to guide the guide target, on the basis of the guide task information. Furthermore, for example, the generation unit decides on a mobile device that guides the guide target, so as to minimize a traveling time of the mobile device required for guiding the guide target around the decided area. Furthermore, for example, in a case where the mobile device configured to guide the guide target includes two or more mobile devices, the travel instruction plan includes travel instruction plans for respective ones of the two or more mobile devices.

### TECHNICAL FIELD

The present technology relates to an information processing apparatus, an information processing method, and a program. The present technology particularly relates to an information processing apparatus and the like for generating a travel instruction plan for a mobile device that guides a guide target.

### BACKGROUND ART

A technique has conventionally been known, which causes a mobile device such as a robot to guide a guide target such as a person or another robot (see, for example, Patent Document 1). Here, mobile devices have limits to their mobility performance and are different in travelable environments. Therefore, in a case where a mobile device guides a guide target, it may be impossible for one mobile device to continue the guidance or it may be difficult for the one mobile device to efficiently continue the guidance, depending on environments.

### CITATION LIST

### Patent Document

Patent Document 1: Japanese Patent Application Laid-Open No. 2021-117095

### SUMMARY OF THE INVENTION

### Problems to be Solved by the Invention

An object of the present technology is to allow a mobile device to efficiently guide a guide target.

### Solutions to Problems

A concept of the present technology involves
an information processing apparatus including
a generation unit that generates a travel instruction plan for a mobile device configured to guide a guide target, on the basis of environment map information on a facility in which the mobile device guides the guide target, mobility performance information on the mobile device, and current information and guide task information on the mobile device.

In the present technology, the generation unit generates the travel instruction plan for the mobile device configured to guide the guide target, on the basis of the environment map information on the facility in which the mobile device guides the guide target, the mobility performance information on the mobile device, and the current information and guide task information on the mobile device.

For example, the generation unit may decide on an area where the mobile device needs to guide the guide target, on the basis of the guide task information. Therefore, it is possible to generate the travel instruction plan for the mobile device such that the mobile device guides the guide target around an area (one area or two or more areas) desired by the guide target.

In this case, for example, the generation unit may decide on the area by referring to a correspondence between guide task information and a location where the mobile device needs to guide the guide target. Therefore, it is possible to appropriately and efficiently decide on an area.

Furthermore, in this case, for example, the generation unit may decide on a mobile device that guides the guide target, so as to minimize a traveling time of the mobile device required for guiding the guide target around the decided area. Therefore, it is possible to decide on a mobile device (one mobile device or two or more mobile devices) that guides the guide target, so as to minimize a traveling time of the mobile device.

For example, in a case where the mobile device configured to guide the guide target includes two or more mobile devices, the travel instruction plan may include travel instruction plans for respective ones of the two or more mobile devices. Therefore, it is possible to appropriately provide cooperative travel instructions to two or more mobile devices.

In this case, for example, the travel instruction plan may include information on a transfer method in transferring guidance to the guide target from a first mobile device to a second mobile device. By including information on the transfer method as described above, for example, it is possible to easily and appropriately provide an instruction about where the guide target should go, to the guide target in transferring the guidance to the guide target from the first mobile device to the second mobile device.

Furthermore, for example, the environment map information may include an unexecuted travel instruction plan, and in a case where the decided area includes an area overlapping an area in the unexecuted travel instruction plan, the generation unit may generate travel instruction plans for mobile devices that guide the guide target such that the mobile devices guide the guide target in the overlapping area in different time periods. Therefore, it is possible to prevent two or more mobile devices from existing in one area during the same time period and to suppress traveling time variations.

Furthermore, for example, the current information on the mobile device may include current position information on the mobile device. Therefore, it is possible to generate the travel instruction plan for the mobile device that guides the guide target, in consideration of the current position information on the mobile device. Note that information as to whether or not the mobile device currently guides the guide target, information on a current battery charging state of the mobile device, and the like are considered as the current information.

As described above, the present technology generates a travel instruction plan for a mobile device configured to guide a guide target, on the basis of environment map information on a facility in which the mobile device guides the guide target, mobility performance information on the mobile device, and current information and guide task information on the mobile device, and allows the mobile device to efficiently guide the guide target.

Furthermore, another concept of the present technology involves
an information processing method including
generating a travel instruction plan for a mobile device configured to guide a guide target, on the basis of environment map information on a facility in which the mobile device guides the guide target, mobility performance information on the mobile device, and current information and guide task information on the mobile device.

Furthermore, still another concept of the present technology involves
a program for causing a computer to function as
a generation unit that generates a travel instruction plan for a mobile device configured to guide a guide target, on the basis of environment map information on a facility in which the mobile device guides the guide target, mobility performance information on the mobile device, and current information and guide task information on the mobile device.

### BRIEF DESCRIPTION OF DRAWINGS

FIG. 1 is a diagram for explaining a problem in a case where one guide robot continuously guides a person.

FIG. 2 is a diagram for explaining that it is possible to efficiently guide a person, by taking environment map information, mobility performance of a guide robot, and the like into consideration and adaptively using one guide robot or two or more guide robots.

FIG. 3 is a diagram illustrating an exemplary configuration of a guide robot placement system that provides travel instructions to multiple guide robots.

FIG. 4 is a flowchart illustrating exemplary processing procedures of a task management processing unit.

FIG. 5 is a flowchart illustrating exemplary processing procedures of a robot current information management unit.

FIG. 6 is a diagram illustrating exemplary guide task map information managed by a guide task map information database in a case where a facility in which a guide robot guides a person is an art gallery.

FIG. 7 is a flowchart illustrating exemplary processing procedures of a robot placement calculation unit.

FIG. 8 is a diagram for explaining specific examples of decision on guide patterns and calculation of a traveling time of a guide robot in each guide pattern.

FIG. 9 is a diagram for explaining exemplary travel instruction plans in a case where one guide robot transfers guidance to another guide robot.

FIG. 10 is a flowchart illustrating exemplary processing procedures of a robot instruction unit.

FIG. 11 is a block diagram illustrating an exemplary hardware configuration of a computer.

### MODE FOR CARRYING OUT THE INVENTION

A mode for carrying out the invention (hereinafter, referred to as an “embodiment”) will be described below. Note that the description is given in the following order.
1. Embodiment
2. Modifications

### 1. Embodiment

### [Description Concerning the Present Technology]

The present technology allows a mobile device to efficiently guide a guide target. Note that the following description is given using an exemplary case where the mobile device is a guide robot and the guide target is a person.

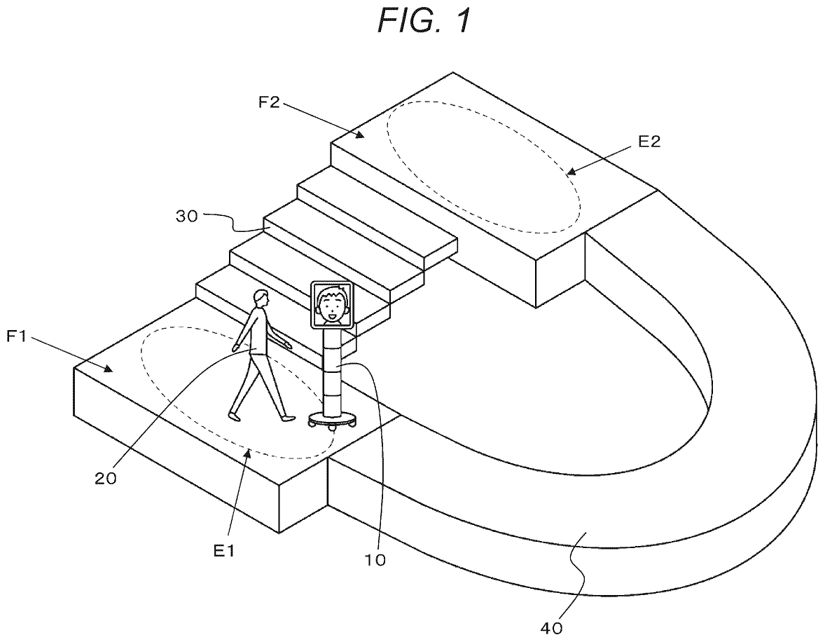

In a case where a guide robot guides a person, it may be impossible for one guide robot to continue the guidance or it may be difficult for the one guide robot to efficiently continue the guidance, depending on environments. For example, as illustrated in FIG. 1, an environment with a staircase 30 is considered. A case where one guide robot 10 guides a person 20 around an area E1 on a floor F1 connected to a lower end of the staircase and then guides the person 20 around an area E2 on a floor F2 connected to an upper end of the staircase is assumed in this environment.

In a case where the guide robot 10 is incapable of going up the staircase 30 with its mobility performance, the guide robot 10 cannot move from the area E1 to the area E2 along a route of going up the staircase 30. As a result, the guide robot 10 moves from the area E1 to the area E2 along a route of passing a slope 40 in order to guide the person 20, which is inefficient. Note that in this case, if there is no slope 40, the guide robot 10 cannot move from the area E1 to the area E2; therefore, the guide robot 10 cannot guide the person 20.

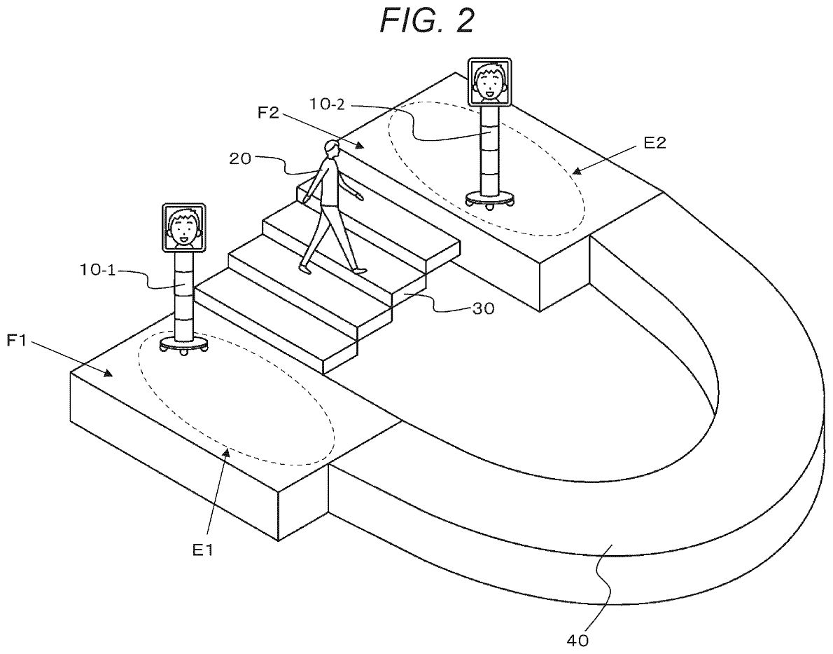

The present technology takes environment map information, mobility performance of a guide robot, and the like into consideration and adaptively uses one guide robot or two or more guide robots, thereby efficiently guiding the person 20. For example, as illustrated in FIG. 2, an environment with a staircase 30 is considered as in the foregoing environment illustrated in FIG. 1. In this case, with regard to an area E1 on a floor F1 connected to a lower end of the staircase, a guide robot 10-1 that is present on this floor F1 guides a person 20. Thereafter, only the person 20 goes up the staircase 30 to move from the floor F1 to a floor F2 connected to an upper end of the staircase. With regard to an area E2 on this floor F2, a guide robot 10-2 that is present on this floor F2 guides the person 20. It is thus possible to efficiently guide the person 20. In this case, the guide robot 10-1 that is present on the floor F1 transfers the guidance to the person 20 to the guide robot 10-2 that is present on the floor F2.

### “Guide Robot Placement System”

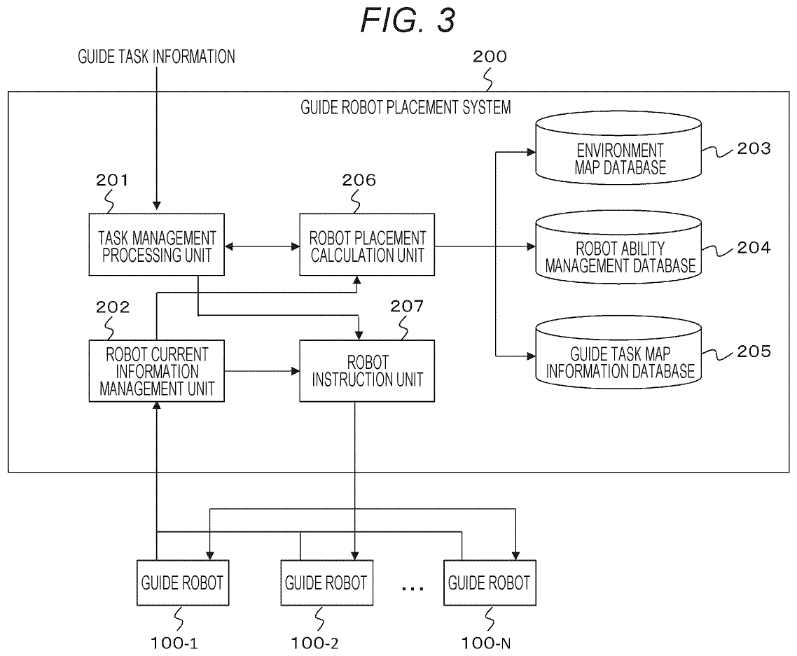

FIG. 3 illustrates an exemplary configuration of a guide robot placement system 200 that wirelessly provides travel instructions to multiple guide robots, here, N guide robots 100-1 to 100-N. This guide robot placement system 200 may be present in a facility, such as an art gallery, a museum, a zoo, an aquarium, an amusement park, a company, a school, or a public office, in which the guide robots 100-1 to 100-N guide a person, or may be present in other places. For example, this guide robot placement system 200 may include a server on a cloud, that is, a server connected to the Internet.

The guide robot placement system 200 includes a task management processing unit 201, a robot current information management unit 202, an environment map database 203, a robot ability management database 204, a guide task map information database 205, a robot placement calculation unit 206, and a robot instruction unit 207.

The task management processing unit 201 externally receives information on a guide task to be executed by a guide robot (guide task information). The guide task differs variously depending on use cases. For example, in a case where a facility in which the guide robots 100-1 to 100-N guide a person is an art gallery, examples of the guide task include to introduce a certain work, to introduce the works of a certain artist, to introduce the works during a certain age, and the like. Furthermore, for example, in a case where a facility in which the guide robots 100-1 to 100-N guide a person is a company, examples of the guide task include to lead to a certain conference room, to lead to a restroom, and the like.

This guide task can be input in such a manner that a person to be guided (hereinafter, appropriately referred to as a “guide target person”) or an operator manipulates a terminal device placed in a facility in which the guide robots 100-1 to 100-N guide a person or the guide target person manipulates his/her portable terminal such as a smartphone or a tablet. Note that this guide task may be input by voice.

Furthermore, in a case where the task management processing unit 201 receives the guide task information, the task management processing unit 201 requests the robot placement calculation unit 206 to generate a travel instruction plan for a guide robot that guides the guide target person, in accordance with the guide task information. Furthermore, the task management processing unit 201 receives from the robot placement calculation unit 206 the travel instruction plan for the guide robot that guides the guide target person, and requests the robot instruction unit 207 to execute the travel instruction plan, in accordance with the travel instruction plan.

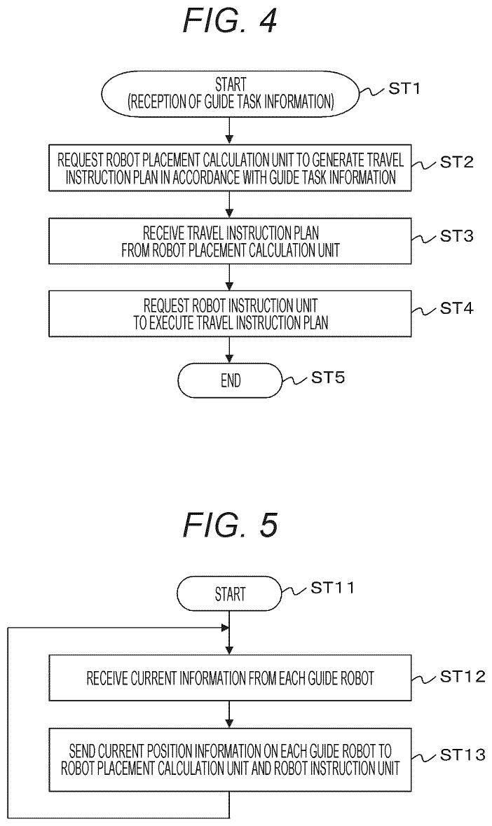

A flowchart of FIG. 4 illustrates exemplary processing procedures of the task management processing unit 201. The task management processing unit 201 starts the processing when externally receiving guide task information in step ST1. In step ST2, then, the task management processing unit 201 requests the robot placement calculation unit 206 to generate a travel instruction plan for a guide robot that guides the guide target person, in accordance with the guide task information.

In step ST3, next, the task management processing unit 201 receives from the robot placement calculation unit 206 the travel instruction plan for the guide robot that guides the guide target person. In step ST4, next, the task management processing unit 201 requests the robot instruction unit 207 to execute the travel instruction plan for the guide robot that guides the guide target person, in accordance with the travel instruction plan. In step ST5, thereafter, the task management processing unit 201 ends the processing.

The robot current information management unit 202 receives current information from each of the guide robots 100-1 to 100-N. This current information includes current position information. This current information may further include information as to whether or not the relevant guide robot currently guides the guide target person, information on a current battery charging state, and the like. In this embodiment, as will be described later, the robot placement calculation unit 206 uses the current position information on each of the guide robots 100-1 to 100-N. The robot placement calculation unit 206 may further use other kinds of information.

Furthermore, the robot current information management unit 202 sends the current position information on each of the guide robots 100-1 to 100-N to the robot placement calculation unit 206 and the robot instruction unit 207. Note that the robot current information management unit 202 periodically receives the current information from each of the guide robots 100-1 to 100-N and, accordingly, the current position information on each of the guide robots 100-1 to 100-N, which the robot current information management unit 202 sends to the robot placement calculation unit 206 and the robot instruction unit 207, is updated in succession.

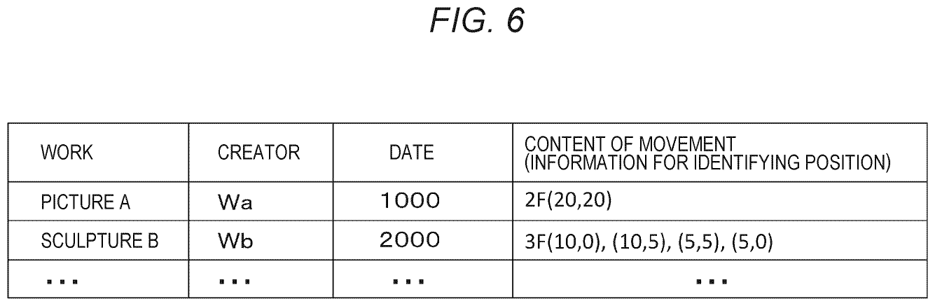

A flowchart of FIG. 5 illustrates exemplary processing procedures of the robot current information management unit 202. The robot current information management unit 202 starts the processing in step ST11. In step ST12, then, the robot current information management unit 202 receives current information from each of the guide robots 100-1 to 100-N. In step ST13, next, the robot current information management unit 202 sends current position information on each of the guide robots 100-1 to 100-N to the robot placement calculation unit 206 and the robot instruction unit 207.

Note that in a case where the robot placement calculation unit 206 uses, in addition to the current position information, other kinds of information included in the current information, such as the information as to whether or not the relevant guide robot currently guides the guide target person and the information on the current battery charging state, these kinds of information are also sent to the robot placement calculation unit 206.

After the processing in step ST13, the robot current information management unit 202 returns to step ST12 in which the robot current information management unit 202 repeats processing similar to the foregoing processing.

The environment map database 203 manages the map information (environment map information) on the facility in which the guide robots 100-1 to 100-N guide a guide target person. Information usable as this map information is, for example, CAD information or 3D map information created using sensor information. Note that a user may use a tool to add, for example, step difference information such as a groove in a floor for automatic doors to the CAD information or the 3D map information so as to enhance the accuracy of the CAD information or 3D map information.

The robot ability management database 204 manages the mobility performance of each of the robots 100-1 to 100-N. This mobility performance includes a step that each guide robot can climb over, a slope (a gradient) that each guide robot can go up, a slope (a gradient) that each guide robot can go down, a traveling speed when each guide robot moves a flat area, a traveling speed when each guide robot goes up an up slope, a traveling speed when each guide robot goes down a down slope, a traveling speed when each guide robot climbs over a step, and the like.

Using the map information (the environment map information) managed by the environment map database 203 and the mobility performance of each of the robots 100-1 to 100-N managed by the robot ability management database 204, it is possible to determine which route in the facility each of the guide robots 100-1 to 100-N can travel and how much traveling time each of the robots 100-1 to 100-N will take.

The guide task map information database 205 manages guide task map information including a predetermined number of correspondences (entries) between guide task information and a location where each of the guide robots 100-1 to 100-N needs to guide the guide target person.

FIG. 6 illustrates exemplary guide task map information managed by the guide task map information database 206 in a case where a facility in which the guide robots 100-1 to 100-N guide the guide target person is an art gallery. Here, the items “work”, “creator”, and “date” each form guide task information, and the content of travel (information for identifying a location) forms a location where each of the guide robots 100-1 to 100-N needs to guide the guide target person.

In the illustrated example, guide task information on “picture A”, guide task information on “creator Wa”, and guide task information on “the 1000s” are each correlated with a location “2F (20, 20)” where a corresponding one of the guide robots 100-1 to 100-N needs to guide the guide target person. Note that “2F (20, 20)” indicates a position (20, 20) on the second floor. Here, (a, b) indicates that the X coordinate is “a” while the Y coordinates is “b”. Furthermore, in the illustrated example, guide task information on “sculpture B”, guide task information on “creator Wb”, and guide task information on “the 2000s” are each correlated with a location “3F (10, 0), (10, 5), (5, 5), (5, 0)” where a corresponding one of the guide robots 100-1 to 100-N needs to guide the guide target person.

Using the correspondence (entry) between the guide task information and the location where each of the guide robots 100-1 to 100-N needs to guide the guide target person, the correspondence (entry) being managed by the guide task map information database 205, it is possible to grasp the location where each of the guide robots 100-1 to 100-N needs to guide the guide target person, on the basis of the guide task information and to decide on one area or two or more areas where the guide robots 100-1 to 100-N need to guide the guide target person. In this case, each area includes one location where each of the guide robots 100-1 to 100-N needs to guide the guide target person or two or more neighboring locations where each of the guide robots 100-1 to 100-N needs to guide the guide target person.

The robot placement calculation unit 206 receives from the task management processing unit 201 a request to generate a travel instruction plan for a guide robot that guides a guide target person, in accordance with guide task information. Then, the robot placement calculation unit 206 generates the travel instruction plan for the guide robot that guides the guide target person, and sends the travel instruction plan to the task management processing unit 201.

The robot placement calculation unit 206 generates the travel instruction plan for the guide robot that guides the guide target person, on the basis of, in addition to the guide task information, environment map information on a facility in which the guide robots 100-1 to 100-N guide the guide target person, the environment map information being managed by the environment map database 203, mobility performance information on each of the guide robots 100-1 to 100-N, the mobility performance information being managed by the robot ability management database 204, and current position information on each of the guide robots 100-1 to 100-N, the current position information being sent from the robot current information management unit 202.

In this case, the robot placement calculation unit 206 refers to a correspondence (entry) between the guide task information and a location where each of the guide robots 100-1 to 100-N needs to guide the guide target person, the correspondence (entry) being managed by the guide task map information database 205, to grasp the location where each of the guide robots 100-1 to 100-N needs to guide the guide target person, on the basis of the guide task information, and to decide on one area or two or more areas where the guide robots 100-1 to 100-N need to guide the guide target person.

Also in this case, the robot placement calculation unit 206 decides on at least one of the guide robots 100-1 to 100-N that guide the guide target person so as to minimize traveling times of the guide robots 100-1 to 100-N required for guiding the guide target person around the decided area or areas, using the environment map information on the facility in which the guide robots 100-1 to 100-N guide the guide target person, the mobility performance information on each of the guide robots 100-1 to 100-N, and the current position information on each of the guide robots 100-1 to 100-N. In this case, one guide robot or two or more guide robots are decided as the at least one of the guide robots 100-1 to 100-N that guide the guide target person. In a case where two or more guide robots are decided, the two or more guide robots guide the guide target person while transferring the guidance one after another.

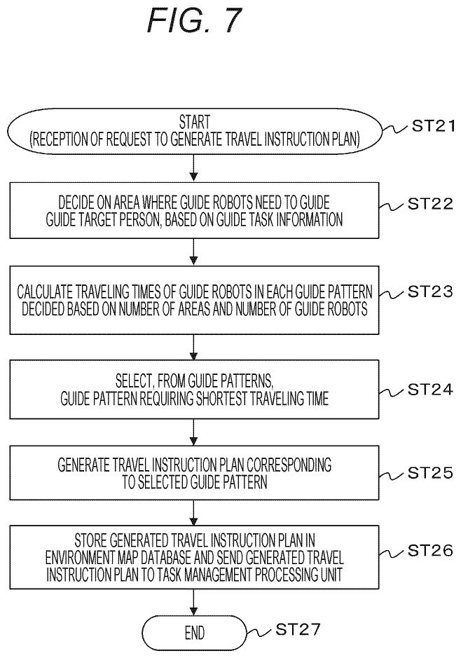

A flowchart of FIG. 7 illustrates exemplary processing procedures of the robot placement calculation unit 206. The robot placement calculation unit 206 starts the processing when receiving from the task management processing unit 201 a request to generate a travel instruction plan for a guide robot that guides a guide target person, in accordance with guide task information in step ST21.

Next, in step ST22, the robot placement calculation unit 206 refers to a correspondence (entry) between the guide task information and a location where each of the guide robots 100-1 to 100-N needs to guide the guide target, the correspondence (entry) being managed by the guide task map information database 205, to decide on one area or two or more areas where the guide robots 100-1 to 100-N need to guide the guide target person, on the basis of the guide task information included in the request to generate the travel instruction plan, the request being sent from the task management processing unit 201.

In step ST23, next, the robot placement calculation unit 206 decides on the predetermined number of guide patterns to be decided on the basis of the number of areas and the number of guide robots, and calculates traveling times of the guide robots in each guide pattern (times for movement), using environment map information on a facility in which the guide robots 100-1 to 100-N guide the guide target person, mobility performance information on each of the guide robots 100-1 to 100-N, and current position information on each of the guide robots 100-1 to 100-N.

The decision on the guide patterns and the calculation of the traveling times of the guide robots in each guide pattern are further described on the basis of specific examples.

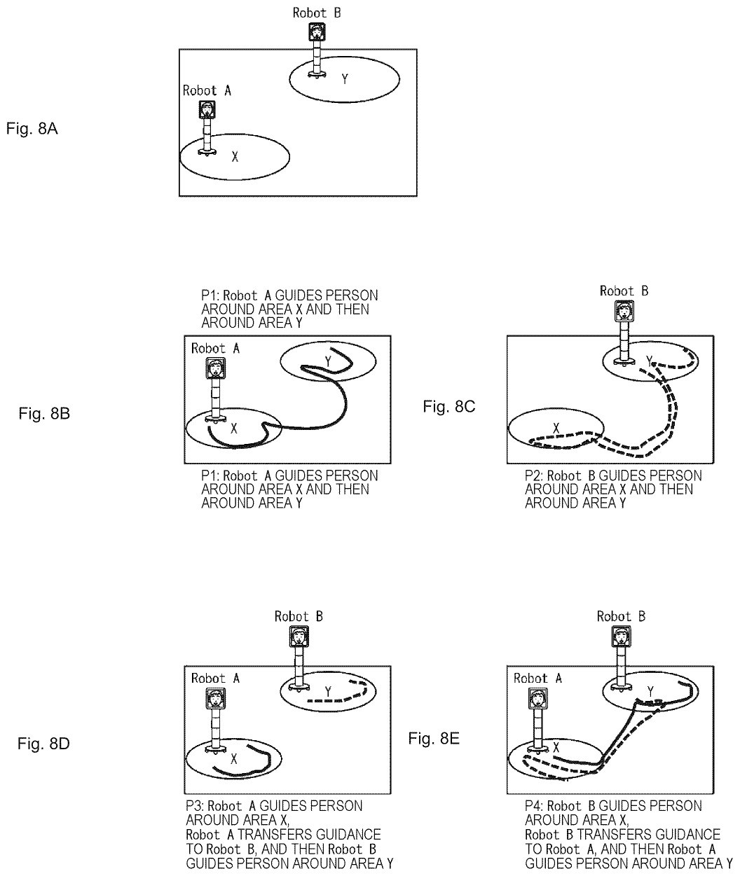

As illustrated in FIG. 8(a), here, it is assumed that an area X and an area Y are decided as areas where the robots 100-1 to 100-N need to guide the guide target person and, among the robots 100-1 to 100-N, a robot A (Robot A) and a robot B (Robot B) guide the guide target person around the area X and then around the area Y.

In this case, four guide patterns are decided, which include: a guide pattern P1 in which the robot A guides the guide target person around the area X and then around the area Y as illustrated in FIG. 8(b1); a guide pattern P2 in which the robot B guides the guide target person around the area X and then around the area Y as illustrated in FIG. 8(b2); a guide pattern P3 in which the robot A guides the guide target person around the area X, and then the robot B guides the guide target person around the area Y as illustrated in FIG. 8(b3); and a guide pattern P4 in which the robot B guides the guide target person around the area X, and then the robot A guides the guide target area around the area Y as illustrated in FIG. 8(b4).

Then, in the case of the guide pattern P1 illustrated in FIG. 8(b1), with regard to a traveling time of a guide robot, a travel route along which the robot A may most efficiently travel in guiding the guide target person around the area X and then around the area Y as indicated by a solid line is set on the basis of current position information on and mobility performance of the robot A, and a traveling time of the robot A based on the travel route is calculated.

Here, the travel route along which the robot A may most efficiently travel means, among one travel route or two or more travel routes covering no location where the robot A is incapable of traveling by its mobility performance, a travel route along which the robot A is capable of traveling in the shortest traveling time by its mobility performance. This applies to the following other guide patterns.

Furthermore, in the case of the guide pattern P2 illustrated in FIG. 8(b2), with regard to a traveling time of a guide robot, a travel route along which the robot B may most efficiently travel in guiding the guide target person around the area X and then around the area Y as indicated by a broken line is set on the basis of current position information on and mobility performance of the robot B, and a traveling time of the robot B based on the travel route is calculated.

Furthermore, in the case of the guide pattern P3 illustrated in FIG. 8(b3), with regard to a traveling time of a guide robot, a first travel route along which the robot A may most efficiently travel in guiding the guide target person around the area X as indicated by a solid line is set on the basis of the current position information on and mobility performance of the robot A, a second travel route along which the robot B may most efficiently travel in guiding the guide target person around the area Y as indicated by a broken line is set on the basis of the current position information on and mobility performance of the robot B, and a total traveling time of a traveling time of the robot A based on the first travel route and a traveling time of the robot B based on the second travel route is calculated. Note that in the case of this guide pattern, the robot A transfers the guidance to the robot B.

Furthermore, in the case of the guide pattern P4 illustrated in FIG. 8(b4), with regard to a traveling time of a guide robot, a first travel route along which the robot B may most efficiently travel in guiding the guide target person around the area X as indicated by a broken line is set on the basis of the current position information on and mobility performance of the robot B, a second travel route along which the robot A may most efficiently travel in guiding the guide target person around the area Y as indicated by a solid line is set on the basis of the current position information on and mobility performance of the robot A, and a total traveling time of a traveling time of the robot B based on the first travel route and a traveling time of the robot A based on the second travel route is calculated. Note that in the case of this guide pattern, the robot B transfers the guidance to the robot A.

With reference to FIG. 7 again, next, in step ST24, the robot placement calculation unit 206 selects from the guide patterns a guide pattern that requires the shortest traveling time. In this case, for example, the guide pattern illustrated in FIG. 8(b3) is selected from the foregoing four guide patterns illustrated in FIGS. 8(b1) to 8(b4).

Next, in step ST25, the robot placement calculation unit 206 generates a travel instruction plan corresponding to the selected guide pattern. In a case where in the selected guide pattern, multiple guide robots guide a guide target person while transferring the guidance one after another, the travel instruction plan to be generated includes travel instruction plans for respective ones of the multiple guide robots.

Furthermore, in this case, it is considered that the travel instruction plan to be generated further includes a transfer method for informing the guide target person about the transfer. By including the transfer method as described above, for example, it is possible to easily and appropriately inform or instruct the guide target person about where the guide target person should go, in transferring the guidance from one guide robot to another guide robot.

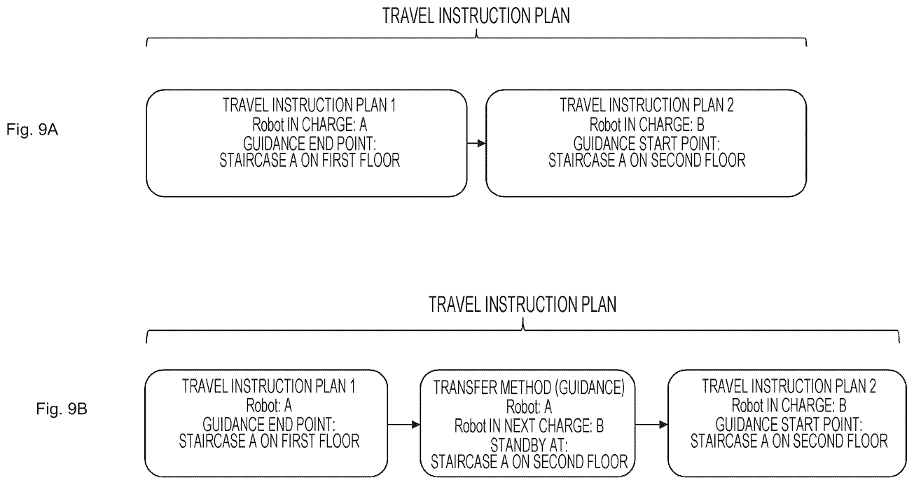

FIG. 9(a) illustrates an exemplary travel instruction plan to be generated in a case where the guide pattern illustrated in FIG. 8(b3) is selected, for example. In the illustrated example, the travel instruction plan includes a travel instruction plan 1 for the robot A and a travel instruction plan 2 for the robot B. Also in the illustrated example, the travel instruction plan 1 for the robot A indicates that a guidance end point is “a staircase A on the first floor”, and the travel instruction plan for the robot B indicates that a guidance start end point is “the staircase A on the second floor”.

FIG. 9(b) illustrates an exemplary case where the travel instruction plan illustrated in FIG. 9(a) further includes a transfer method for informing the guide target person about the transfer. In the illustrated example, the transfer method indicates that “the guide robot A” is in charge of this area, and “the guide robot B” is in charge of the next area, and also indicates that the guide robot B that is in charge of the next area is on standby at “the staircase A on the second floor”. It is thus possible to easily and appropriately provide an instruction “Guide robot A has guided you up to this area, but from here on guide robot B will take over. Please go up staircase A to second floor. Guide robot B is waiting.” to the guide target person by audio output or message display, for example.

Next, in step ST26, the robot placement calculation unit 206 stores the generated travel instruction plan in the environment map database 203 and sends the generated travel instruction plan to the task management processing unit 201. Thereafter, in step ST27, the robot placement calculation unit 206 ends the processing. When the travel instruction plan generated by the robot placement calculation unit 206 is stored in the environment map database 203 as described above, in generating a travel instruction plan for a guide robot next time, it is possible to generate a new travel instruction plan that prevents two or more guide robots from existing in one area during the same time period, by referring to an unexecuted travel instruction plan. It is thus possible to suppress traveling time variations.

With reference to FIG. 3 again, the robot instruction unit 207 executes a travel instruction plan for a guide robot that guides a guide target person, on the basis of a request from the task management processing unit 201. In this case, the robot instruction unit 207 provides a travel instruction to the guide robot that guides the guide target person, while referring to current position information on the guide robot sent from the robot current information management unit 202.

In this case, when two or more guide robots guide a guide target person and one guide robot transfers the guidance to another guide robot, the robot instruction unit 207 instructs the guide robot from which the guidance is transferred and the guide robot to which the guidance is transferred, to transfer the guidance, and informs the guide target person about a fact that the guidance will be transferred, where the guide target person should go, and the like. In the case where the travel instruction plan includes the transfer method as described above, it is possible to appropriately and easily provide information or an instruction to the guide target person, on the basis of this transfer method.

The information about the fact that the guidance will be transferred, where the guide target person should go, and the like is provided to the guide target person by audio output or message display, using an audio output function or an information display function of the guide robot from which the guidance is transferred, or an audio output function or an information display function of a tablet or smartphone registered in advance by the guide target person, for example.

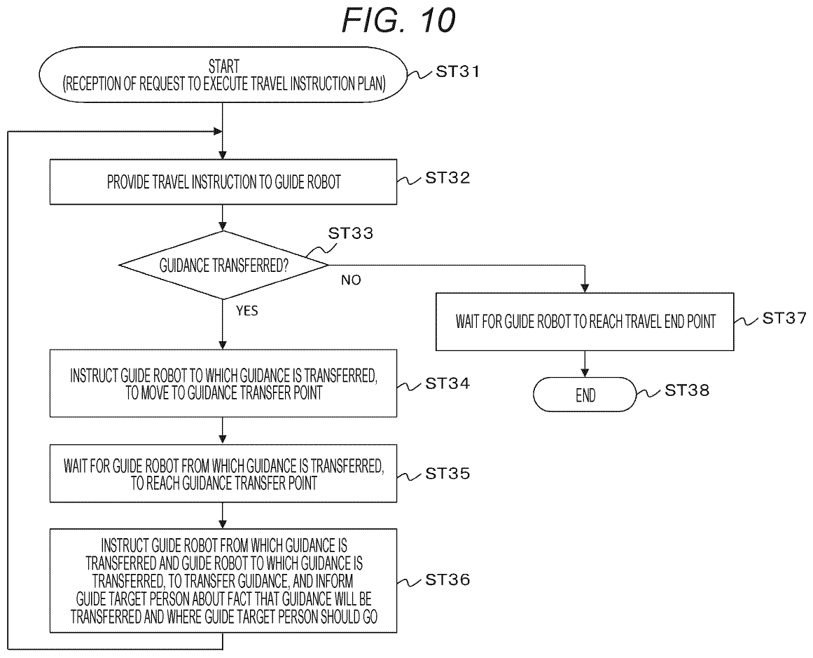

A flowchart of FIG. 10 illustrates exemplary processing procedures of the robot instruction unit 207. The robot instruction unit 207 starts the processing when receiving from the task management processing unit 201 a request to execute a travel instruction plan for a guide robot that guides a guide target person, in accordance with the travel instruction plan in step ST31.

In step ST32, next, the robot instruction unit 207 provides a travel instruction to a guide robot that first guides the guide target person, on the basis of the travel instruction plan. In step ST33, next, the robot instruction unit 207 determines whether or not the guide robot that currently guides the guide target person transfers the guidance to another guide robot.

When the guidance needs to be transferred, the robot instruction unit 207 proceeds to the processing in step ST34. In step ST34, the robot instruction unit 207 instructs the guide robot to which the guidance is transferred, to move to a guidance transfer point. In step ST35, furthermore, the robot instruction unit 207 waits for the guide robot from which the guidance is transferred, to reach the guidance transfer point.

In step ST36, next, the robot instruction unit 207 instructs the guide robot from which the guidance is transferred and the guide robot to which the guidance is transferred, to transfer the guidance and, moreover, informs the guide target person about a fact that the guidance will be transferred, where the guide target person should go, and the like.

After the processing in step ST36, the robot instruction unit 207 returns to the processing in step ST32. In step ST32, the robot instruction unit 207 repeats processing similar to the foregoing processing. Note that in this case, the guide robot to be subjected to the processing in step ST32 corresponds to the guide robot to which the guidance is transferred.

Furthermore, when the guidance is not transferred in step ST33, the robot instruction unit 207 proceeds to the processing in step ST37. In step ST37, the robot instruction unit 207 waits for the guide robot to reach a travel end point. After the processing in step ST37, in step ST38, the robot instruction unit 207 ends the processing.

The operation of the guide robot placement system 200 illustrated in FIG. 3 is described briefly. In a case where guide task information is externally sent to the task management processing unit 201, the guide task management processing unit 201 requests the robot placement calculation unit 206 to generate a travel instruction plan for a guide robot that guides a guide target person, in accordance with the guide task information.

Furthermore, each time the robot current information management unit 202 receives current information from each of the guide robots 100-1 to 100-N, the robot current information management unit 202 sends current position information on each of the guide robots 100-1 to 100-N to the robot placement calculation unit 206 and the robot instruction unit 207. The current position information on each of the guide robots 100-1 to 100-N sent from the robot current information management unit 202 to the robot placement calculation unit 206 and the robot instruction unit 207 is updated in succession.

The robot placement calculation unit 206 that has been requested from the task management processing unit 201 to generate the travel instruction plan generates the travel instruction plan for the guide robot that guides the guide target person, on the basis of, in addition to the guide task information, environment map information on a facility in which the guide robots 100-1 to 100-N guide the guide target person, the environment map information being managed by the environment map database 203, mobility performance information on each of the guide robots 100-1 to 100-N, the mobility performance information being managed by the robot ability management database 204, and current position information on each of the guide robots 100-1 to 100-N, the current position information being sent from the robot current information management unit 202.

In this case, the robot placement calculation unit 206 refers to a correspondence (entry) between the guide task information and a location where each of the guide robots 100-1 to 100-N needs to guide the guide target person, the correspondence (entry) being managed by the guide task map information database 205, to recognize the location where each of the guide robots 100-1 to 100-N needs to guide the guide target person, on the basis of the guide task information, and to decide on one area or two or more areas where the guide robots 100-1 to 100-N need to guide the guide target person.

Also in this case, the robot placement calculation unit 206 decides on at least one of the guide robots 100-1 to 100-N that guide the guide target person so as to minimize traveling times of the guide robots 100-1 to 100-N required for guiding the guide target person around the decided area or areas, using the environment map information on the facility in which the guide robots 100-1 to 100-N guide the guide target person, the mobility performance information on each of the guide robots 100-1 to 100-N, and the current position information on each of the guide robots 100-1 to 100-N.

The task management processing unit 201 receives from the robot placement calculation unit 206 the travel instruction plan for the guide robot that guides the guide target person. Then, the task management processing unit 201 that has received the travel instruction plan requests the robot instruction unit 207 to execute the travel instruction plan in accordance with the travel instruction plan.

The robot instruction unit 203 that has been requested from the task management processing unit 201 to execute the travel instruction plan gives a travel instruction to the guide robot that guides the guide target person, by referring to the current position information on the guide robot sent from the robot current information management unit 202.

In this case, when two or more guide robots guide the guide target person and one guide robot transfers the guidance to another guide robot, the robot instruction unit 207 instructs the guide robot from which the guidance is transferred and the guide robot to which the guidance is transferred, to transfer the guidance, and informs the guide target person about a fact that the guidance will be transferred, where the guide target person should go, and the like.

### “Exemplary Configuration of Computer”

The foregoing processing to be performed by each of the task management processing unit 201, robot current information management unit 202, robot placement calculation unit 206, and robot instruction unit 207 of the guide robot placement system 200 illustrated in FIG. 3 can be performed by hardware or can be performed by software. In a case where the series of processing is performed by software, a program that constitutes the software is installed in a computer incorporated in special-purpose hardware, a general-purpose computer capable of executing various functions by installing various programs, or the like through a recording medium.

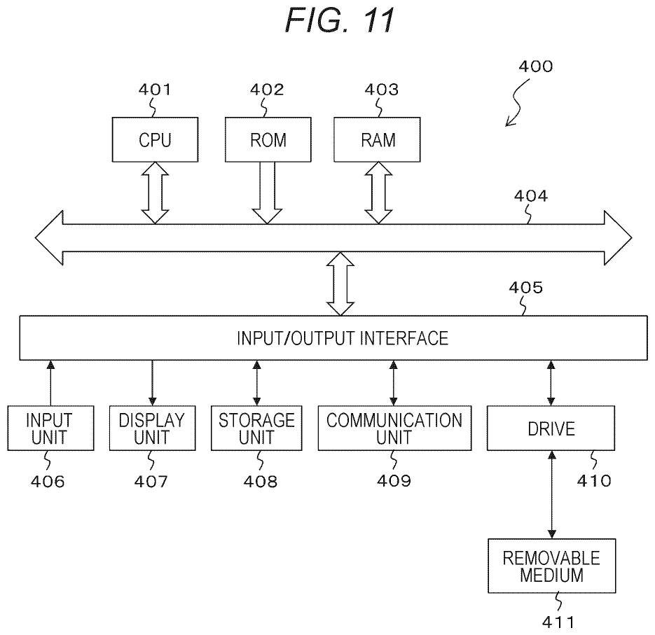

FIG. 11 is a block diagram illustrating an exemplary hardware configuration of a computer 400 that performs the foregoing series of processing by a program.

In the computer 400, a central processing unit (CPU) 401, a read-only memory (ROM) 402, and a random access memory (RAM) 403 are connected to each other via a bus 404.

An input/output interface 405 is also connected to the bus 404. An input unit 406, an output unit 407, a recording unit 408, a communication unit 409, and a drive 410 are connected to the input/output interface 405.

The input unit 406 includes an input switch, a button, a microphone, an imaging element, and the like. The output unit 407 includes a display, speaker, and the like. The recording unit 408 includes a hard disk, a nonvolatile memory, and the like. The communication unit 409 includes a network interface or the like. The drive 410 drives a removable recording medium 411 such as a magnetic disk, an optical disk, a magneto-optical disk, or a semiconductor memory.

The computer 400 configured as described above performs the foregoing series of processing in such a manner that, for example, the CPU 401 loads a program recorded in the recording unit 408 onto the RAM 403 via the input/output interface 405 and the bus 404, and then executes the program.

The program to be executed by the computer 400 (the CPU 401) can be provided in such a manner that, for example, the program is recorded in the removable recording medium 411 serving as a package medium or the like. Furthermore, the program can be provided via a wired or wireless transmission medium such as a local area network, the Internet, or digital satellite broadcasting.

In the computer 400, the program can be installed in the recording unit 408 via the input/output interface 405 with the removable recording medium 411 attached to the drive 410. Furthermore, the program can be installed in the recording unit 408 in such a manner that the program is received at the communication unit 409 via a wired or wireless transmission medium. In addition, the program can be previously installed in the ROM 402 or the recording unit 408.

Note that the program to be executed by the computer may be a program by which processing is performed in a time-series manner in accordance with a sequence described herein, or may be a program by which processing is performed in parallel or at a required timing such as a timing when the program is invoked.

Furthermore, as used herein, the term “system” refers to a set of multiple constituent elements (e.g., devices, modules (components)) irrespective of whether or not all the constituent elements are present in a single housing. Therefore, the term “system” involves multiple devices accommodated in separate housings and connected to each other via a network, and a single device including multiple modules accommodated in a single housing.

In addition, embodiments of the present technology are not limited to the foregoing embodiment and may be modified variously without departing from the scope of the present technology.

For example, the present technology may adopt a configuration of cloud computing in which one function is shared between multiple devices via a network such that the devices process this function in cooperation.

Furthermore, each step described in the foregoing flowcharts may be carried out by a single device or may be carried out by multiple devices in a shared manner.

In addition, in a case where one step includes multiple processes, the multiple processes in the one step may be performed by a single device or may be performed by multiple devices in a shared manner.

As described above, the robot placement calculation unit 206 of the guide robot placement system 200 illustrated in FIG. 3 generates a travel instruction plan for a guide robot that guides a guide target person on the basis of environment map information on a facility in which the mobile device guides the guide target, mobility performance information on the mobile device, and current information and guide task information on the mobile device, and allows the guide robot to efficiently guide the guide target person.

### <2. Modifications>

Note that preferred embodiments of the present disclosure have been specifically described above while referring to the accompanying drawings; however, the technical scope of the present disclosure is not limited to these examples. It is apparent that a person who has common knowledge in the technical field of the present disclosure may conceive various variations and modifications within the range of the technical idea recited in the claims. It is also understood that these variations and modifications are of course pertinent to the technical scope of the present disclosure.

Furthermore, the advantageous effects described herein are merely descriptive or illustrative, but not limitative. That is, the technology according to the present disclosure may produce other advantageous effects obvious for a person skilled in the art from the description herein, in addition to the foregoing advantageous effects or in place of the foregoing advantageous effects.

Furthermore, the present technology may adopt the following configurations.

(1)

An information processing apparatus including
a generation unit that generates a travel instruction plan for a mobile device configured to guide a guide target, on the basis of environment map information on a facility in which the mobile device guides the guide target, mobility performance information on the mobile device, and current information and guide task information on the mobile device.
   (2)

The information processing apparatus as recited in (1), in which
the generation unit decides on an area where the mobile device needs to guide the guide target, on the basis of the guide task information.
   (3)

The information processing apparatus as recited in (2), in which
the generation unit decides on the area by referring to a correspondence between guide task information and a location where the mobile device needs to guide the guide target.
   (4)

The information processing apparatus as recited in (2) or (3)2, in which the generation unit decides on a mobile device that guides the guide target, so as to minimize a traveling time of the mobile device required for guiding the guide target around the decided area.

(5)

The information processing apparatus as recited in any one of (1) to (4), in which
in a case where the mobile device configured to guide the guide target includes two or more mobile devices, the travel instruction plan includes travel instruction plans for respective ones of the two or more mobile devices.
   (6)

The information processing apparatus as recited in (5), in which
the travel instruction plan includes information on a transfer method in transferring guidance to the guide target from a first mobile device to a second mobile device.
   (7)

The information processing apparatus as recited in any one of (2) to (6), in which
the environment map information includes an unexecuted travel instruction plan, and
in a case where the decided area includes an area overlapping an area in the unexecuted travel instruction plan, the generation unit generates travel instruction plans for mobile devices that guide the guide target such that the mobile devices guide the guide target in the overlapping area in different time periods.
   (8)

The information processing apparatus as recited in any one of (1) to (7), in which
the current information on the mobile device includes current position information on the mobile device.
   (9)

An information processing method including
generating a travel instruction plan for a mobile device configured to guide a guide target, on the basis of environment map information on a facility in which the mobile device guides the guide target, mobility performance information on the mobile device, and current information and guide task information on the mobile device.
   (10)

A program for causing a computer to function as
a generation unit that generates a travel instruction plan for a mobile device configured to guide a guide target, on the basis of environment map information on a facility in which the mobile device guides the guide target, mobility performance information on the mobile device, and current information and guide task information on the mobile device.

### REFERENCE SIGNS LIST

100-1 to 100-3 Guide robot
200 Guide robot placement system
201 Task management processing unit
202 Robot current information management unit
203 Environment map database
204 Robot ability management database
205 Guide task map information database
206 Robot placement calculation unit
207 Robot instruction unit

1. An information processing apparatus comprising
a generation unit that generates a travel instruction plan for a mobile device configured to guide a guide target, on a basis of environment map information on a facility in which the mobile device guides the guide target, mobility performance information on the mobile device, and current information and guide task information on the mobile device.

2. The information processing apparatus according to claim 1, wherein
the generation unit decides on an area where the mobile device needs to guide the guide target, on a basis of the guide task information.

3. The information processing apparatus according to claim 2, wherein
the generation unit decides on the area by referring to a correspondence between guide task information and a location where the mobile device needs to guide the guide target.

4. The information processing apparatus according to claim 2, wherein
the generation unit decides on a mobile device that guides the guide target, so as to minimize a traveling time of the mobile device required for guiding the guide target around the decided area.

5. The information processing apparatus according to claim 1, wherein
in a case where the mobile device configured to guide the guide target includes two or more mobile devices, the travel instruction plan includes travel instruction plans for respective ones of the two or more mobile devices.

6. The information processing apparatus according to claim 5, wherein
the travel instruction plan includes information on a transfer method in transferring guidance to the guide target from a first mobile device to a second mobile device.

7. The information processing apparatus according to claim 2, wherein
the environment map information includes an unexecuted travel instruction plan, and
in a case where the decided area includes an area overlapping an area in the unexecuted travel instruction plan, the generation unit generates travel instruction plans for mobile devices that guide the guide target such that the mobile devices guide the guide target in the overlapping area in different time periods.

8. The information processing apparatus according to claim 1, wherein
the current information on the mobile device includes current position information on the mobile device.

9. An information processing method comprising
generating a travel instruction plan for a mobile device configured to guide a guide target, on a basis of environment map information on a facility in which the mobile device guides the guide target, mobility performance information on the mobile device, and current information and guide task information on the mobile device.

10. A program for causing a computer to function as
a generation unit that generates a travel instruction plan for a mobile device configured to guide a guide target, on a basis of environment map information on a facility in which the mobile device guides the guide target, mobility performance information on the mobile device, and current information and guide task information on the mobile device.
